(19) United States
(12) Patent Application Publication
(10) Pub. No.: US 2008/0017255 A1
(43) Pub. Date: Jan. 24, 2008

(54) Spring and a Valve Incorporating Such a Spring

(75) Inventor: Hans Kurt Petersen, Kolding (DK)

Correspondence Address: MCCORMICK, PAULDING & HUBER LLP, CITY PLACE II, 185 ASYLUM STREET, HARTFORD, CT, 06103, US

(73) Assignee: DANFOSS A/S, NORDBORG (DK)

(21) Appl. No.: 11/662,158

(22) PCT Filed: Sep. 9, 2005
(86) PCT No.: PCT/DK05/00575

§ 371 Date: Mar. 7, 2007

(30) Foreign Application Priority Data
Sep. 10, 2004 (DK) PA 2004 01374

(51) Int. Cl. F16K 17/00; F16F 1/04

(52) U.S. Cl. 137/522; 267/167

(57) ABSTRACT

The invention provides an assembly spring and a valve incorporating such a spring. The spring is made from a wire which extends around a longitudinal axis to form windings. The spring terminates in axially opposite end portions in first and second end windings. The end windings each has an arcuate portion wherein the wire extends around the longitudinal axis. The end windings serve to fasten the spring in a groove of an element to which the spring is being attached. The end winding further has a free end portion wherein a free wire end extends outwardly away from the longitudinal axis to form gripping means. The spring thereby facilitates easy attaching of the end winding to the element. In particular, the spring is applicable for attaching a valve element to a plunger in a valve, e.g. a servo valve.

### CROSS REFERENCE TO RELATED APPLICATIONS

This application is entitled to the benefit of and incorporates by reference essential subject matter disclosed in International Patent Application No. PCT/DK2005/000575 filed on Sep. 9, 2005 and Danish Patent Application No. PA 2004 01374 filed Sep. 10, 2004.

### FIELD OF THE INVENTION

The invention relates to a spring made from a wire which is wound around a longitudinally extending axis. The spring comprises an intermediate portion with intermediate windings wound in a general winding direction around the centre axis and being located between axially opposite end portions terminating the spring in first and second end windings. The first end winding comprises an arcuate portion wherein the wire extends around the longitudinal axis, a connecting wire portion extending towards the intermediate portion, and a free wire end portion.

The invention further relates to a valve for fluid control in flow systems and incorporating such a spring. The valve forms a passage between an inlet and an outlet and comprises a valve member movable between a closed and an open position for closing and opening the fluid passage. The valve further comprises a plunger operating to move the valve member between the closed and the open position. The plunger could be operated manually, e.g. via a handle, or automatically e.g. via a solenoid. The plunger and the valve member are interconnected by the spring.

### BACKGROUND OF THE INVENTION

In general, valves wherein the valve member is influenced by a spring are known in the art. In this regards, the spring may serve various purposes. As an example, the plunger could be operated manually from a “closed” position to an “open” position whereby the spring is loaded to exert an opening force onto the valve member. If, however, the valve member is strongly affixed to its valve seat, e.g. due to a large pressure difference between the inlet and the outlet of the valve, the actual moving of the valve member can be postponed to a moment when the pressures equalise. In US 2003/0132409, a closure member of a valve is biased against a valve seat by the force of a spring. In the arrangement of the US application, the valve is actuated by a solenoid, and in this specific implementation, a main valve is biased by a first spring in the opening direction, and to facilitate specific needs, the reference teaches the use of an additional spring to act against the force of which a pilot valve opening is opened by an electromagnet.

A plunger interconnected to a valve member by a spring is most commonly seen in combination with servo valves. In a servo valves a pilot valve controls a main valve. In a forced servo valve, the main valve is maintained in a predetermined position by a resilient connection between a pilot valve member and a closure member of the main valve. Servo valves incorporate a pilot passage of a small cross-sectional size compared with the main valve passage of the valve. The pilot passage connects the inlet or the outlet of the valve with a pilot chamber and the flow through the pilot passage, and thereby the pressure in the pilot chamber, is controllable via a pilot closure member. The pilot chamber is located so that the internal pressure of the pilot chamber acts on one surface of the main valve member while the pressure of at least one of the inlet or outlet of the main passage of the valve acts on an opposite surface of the main valve member. By the use of pressure acting on the two opposite side surfaces of the valve member, the valve member is brought into an open or closed state by use of relatively low forces acting on the pilot closure member. In such a valve design, the main valve member is held in its open position by a pressure difference between the inlet, the outlet and the pilot chamber, and since the pressure difference in certain applications may disappear, or be reduced to a level which is insufficient to sustain the main valve member in an open position, the main valve member is sometimes held in an open position by a spring.

In the valve assembly process, it has been found that it is complicated to attach the spring firmly to the valve member and to the plunger, and the spring therefore has a large impact on the costs in valve production.

### SUMMARY OF THE INVENTION

The invention has as its object, the provision of a spring and a valve incorporating such a spring and which is easy to assemble. Accordingly, the invention in a first aspect provides the spring mentioned in the introduction, characterised in that at least a part of the free wire end portion extends outwardly away from the longitudinal axis e.g. to form gripping means or to form a protrusion which can be used for pressing the spring in an axial direction during fitting of the spring e.g. onto an elongate member such as a main valve member or onto a pilot valve member of a valve, or to form a guide for a member to be pushed radially into engagement with the end winding.

Due to the free end portion, attachment of the spring onto elongate members, e.g. for fastening of the end windings in grooves has been facilitated, and in particular in combination with manufacturing of valves, e.g. valves of a very compact design, attachment of the spring to the valve member has been facilitated. In the assembly procedure, an assembly tool, e.g. a piston or stamp can punch the spring in an axial direction down over an end portion of the elongate member by exerting pressure on the outwardly extending free wire end. To further facilitate this pressing process, a part of the connecting wire portion may also extend outwardly to form a protrusion by which a pressing tool can press the spring axially onto the elongate member.

In the remaining part of this specification, the spring will be described in combination with a valve, e.g. a servo valve. The spring is, however, applicable in connection with many other devices, in particular in applications wherein an end winding of a spring is fastened to another part by fixation of the end winding into a groove of the other part.

The arcuate portion could preferably be a circular portion. For attaching the spring to the plunger or to the valve member, the circular arcuate portion could be inserted into a circular circumferentially extending groove in a plunger or in a valve member with a circular cross-sectional shape. For establishing a firm connection, the circular portion could have an inner radial size, i.e. an opening size through the winding, which opening size is slightly smaller than an outer radial size of a bottom part of the groove. In this embodiment, the entire spring, i.e. the end windings and the intermediate portion may similarly have circular windings thus forming the shape of a helical coil spring comprising the gripping means formed by the free wire end, and optionally with the outwardly extending connecting wire portion.

The wire could be an extruded wire, e.g. made from spring steel, which is subsequently wound around the longitudinal axis using standard spring winding techniques. In one embodiment, however, the spring is made from a polymeric or composite material, e.g. by moulding. The spring may have anything from three windings, i.e. two end windings and one winding forming the intermediate portion up to any number of windings. In one specific embodiment, the spring may even be formed from only two windings, i.e. the end windings. In this embodiment, the intermediate portion is constituted by alternative axially flexible means, e.g. by a bellow.

To further facilitate the fitting of the end winding of the spring into a groove, the end winding could be disposed at a larger distance from an adjacent winding than the distance between windings of the intermediate portion. As an example, the connecting portion of one of the end windings could extend in the axial direction thereby to displace the end winding a certain distance away from the intermediate portion. In another example, the pitch, i.e. the degree of slope of the helical windings, could be increased towards the end windings. Due to the larger distance, it is easier to isolate that end winding from other windings for easy locating of the winding into the groove. In one embodiment, both of the end windings comprises an arcuate portion wherein the wire extends around the longitudinal axis, a connecting wire portion extending towards the intermediate portion, and a free wire end portion extending away from the longitudinal axis, e.g. radially away from the axis. In this embodiment, the connecting wire portion of the first end winding could extend outwardly away from the longitudinal axis to form a protrusion on which the previously mentioned assembly tool can press the spring in an axial direction onto an elongate member. The connecting wire portion of the second end winding could extend in the longitudinal direction, i.e. parallel to the longitudinal axis, to provide the distance between the end winding and the adjacent winding of the intermediate portion.

To further improve the assembly procedure, the end winding could be wound in a direction which is opposite the general coiling direction of the windings of the intermediate portion. By such reversing of the winding direction with respect to the end winding, a better defined opening could be created for the valve member or plunger to move radially into a space encircled by the end winding. In particular, the combination between the joining of the end winding to the intermediate portion by a wire portion extending in the axial direction and the reversing of the direction of the end winding with respect to the intermediate portion, could create a free wire loop with a well defined radial opening into the inner space for easy insertion of a plunger or valve member into that space, and for fixation of the wire loop into a groove of the plunger or valve member.

A specifically compact design can be achieved by use of a spring wherein the intermediate portion comprises windings with a larger radial size than one of the first and second end windings. In that way, the end winding and optionally the plunger and/or the valve member is allowed to extend through the windings of the intermediate portion. In fact, the spring may be improved by a design wherein a first winding of the intermediate portion, i.e. a winding adjacent the first end winding, has a first radial size and wherein the windings are consecutively getting larger and larger until the largest winding being the winding adjacent the second end winding. It is, however, preferred that both of the end windings have smaller radial size than the windings of the intermediate portion. In one embodiment, the wire of the intermediate portion of the spring is wound in one single plane, e.g. in the shape of a helix. In this embodiment, the first end winding is preferably disposed on one side of the plane and the other end winding is disposed on the opposite side of the plane. The first end winding could be connected to the intermediate portion by substantially radially extending connecting wire portions, and the second end winding could be connected to the intermediate portion by a substantially axially extending connecting wire portion. In this embodiment, the spring forms three planes, two of which are defined by the end windings and the third being defined by the intermediate portion.

In the foregoing description, the spring is disclosed in connection with a valve assembly. The valve could be a regular valve with a main valve passage and a valve member operable to control the flow through the passage. In one embodiment, however, the valve is a servo valve with a pilot closure member which is opened by the plunger under influence of magnetism, i.e. a solenoid operated valve. In this design, the passage in question could be a pilot passage between a main valve passage and a pilot chamber, and the spring could be applied to join the plunger and the pilot valve member. To facilitate the attachment of the spring onto the plunger and/or onto the valve member, at least one of the plunger and the valve member may have an axial end portion tapering conically inwardly from the groove towards the end thereby forming an end with a smaller radial size than the radial size of the groove. This will allow the end of the valve member or plunger to be inserted into the spring in an easy manner and by further pressing of the valve member or plunger into the spring, and optionally with simultaneous manipulation of the gripping means, the end winding of the spring is easily entered into the groove, e.g. by use of a pressing tool of the aforementioned kind. Analogously, the spring may in general be applied for attachment to any component of a valve, and it may thus substitute e.g. the springs disclosed in applicant's previous application, c.f. US 2003/0132409.

### BRIEF DESCRIPTION OF THE DRAWINGS

In the following, a preferred embodiment of the invention will be described in further details with reference to the drawing in which:

FIGS. 1a and 1b show a spring according to the invention seen from two different angles,

FIG. 2 shows a plunger and a valve member interconnected by the spring,

FIG. 3 shows a view of a servo valve incorporating the spring, and

FIGS. 4 and 5 show two different end windings of the spring,

FIG. 6 shows the assembly of the spring to an elongated member in the axial direction, and

FIG. 7 shows an assembly sequence wherein the spring is attached to an elongated member sideways.

### DETAILED DESCRIPTION OF THE INVENTION

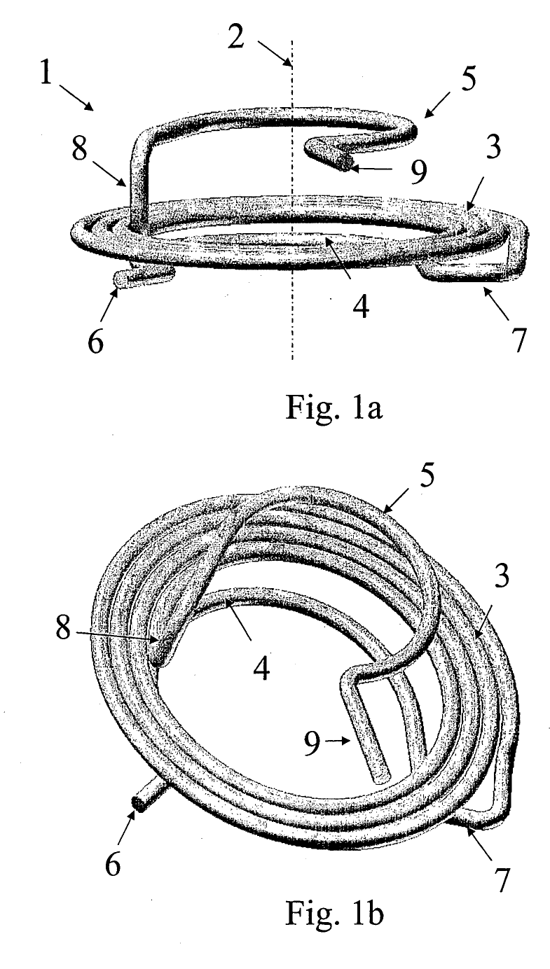

Referring to FIGS. 1a and 1b, the spring 1 is made from a wire which is wound around a longitudinally extending axis 2. The spring comprises an intermediate portion 3 with intermediate windings, and axially opposite end portions terminating the spring in first and second end windings 4, 5. The first end winding 4 comprises a free wire end portion 6 and a connecting wire portion 7 which connects the end winding with the windings of the intermediate portion. In a similar manner, the second end winding 5 comprises a connecting end portion 8 which connects the second winding with the intermediate portion, and a free wire end portion 9. The free wire end portions extend away from the longitudinally extending axis. The intermediate windings are all located in one common plane, and the connecting end portion of the first end winding is located adjacently in close vicinity to the plane. The connecting portion of the second end portion extends in the direction of the axis 2 and thus provides an increased distance between the second end winding and the adjacent winding of the intermediate portion when compared to the distance between adjacent windings of the intermediate portion.

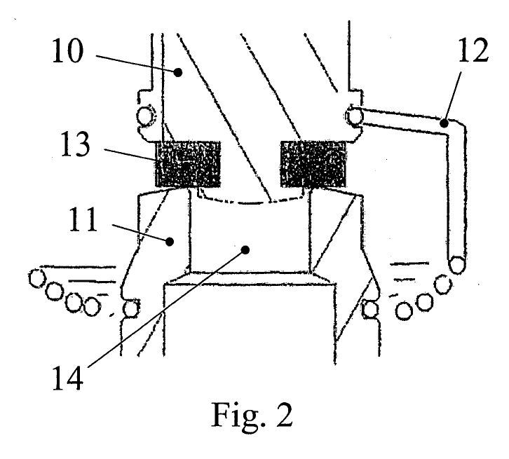

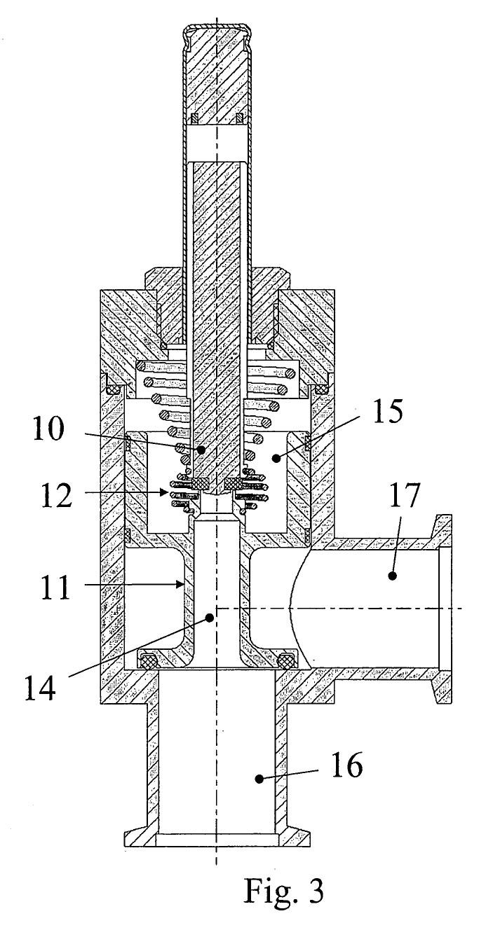

FIG. 2 shows a plunger 10 and a valve member 11 of a servo valve. An almost identical valve is shown in FIG. 3. The plunger and valve member is interconnected by the spring 12. The plunger comprises a gasket 13 of a resilient rubber material. The gasket is fastened to an end portion of the plunger and allows the plunger to close the pilot passage 14 when the plunger is biased towards the opening of the passage. During opening of the valve, the plunger is raised from its position, e.g. under influence of a magnetic field from a solenoid. The raising of the plunger opens the pilot passage, and thus equalises pressure between a pilot chamber 15 and the outlet 16 (the pilot chamber and the inlet 17 and outlet is shown in FIG. 3. When the pressure equalises, a differential between pressures in the chambers 15 and 17, and differences in the sizes of surface areas of the valve member causes the valve member to move upwardly and thereby opens the main valve passage. As it is shown in FIG. 2, both the plunger and the valve member have axial end portion which faces each other, and which taper conically inwardly from the groove towards the end. Due to the reduced radial size of the end, the spring can be attached over the end in an easy manner and by further pressing of the valve member or plunger into the spring the end winding of the spring reaches the groove.

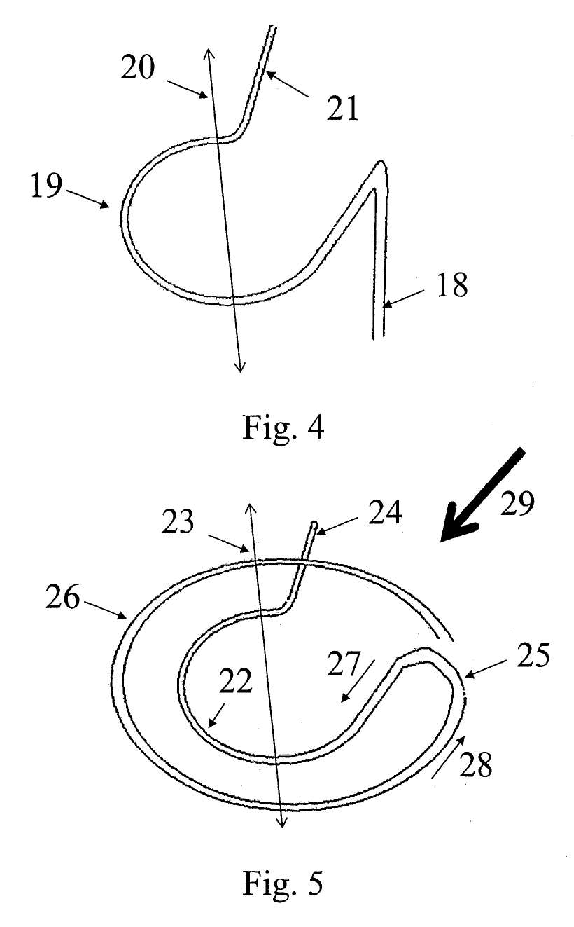

FIG. 4 shows one embodiment of an end winding of the spring. The end winding comprises a connecting wire portion 18 joining the end winding with the windings of the intermediate portion of the spring and an arcuate portion 19 wherein the wire extends around the longitudinal axis 20, and a free end portion 21. The free wire end of the free end portion extends outwardly away from the longitudinal axis and thereby forms gripping means for opening the end winding during the assembly e.g. of the disclosed valve.

FIG. 5 shows another embodiment of an end winding with an arcuate portion 22 wherein the wire extends around a longitudinal axis 23, and a free end portion 24 wherein the free end portion extends outwardly away from the longitudinal axis. In the transition 25 between the arcuate portion 22 and the last winding 26 of the intermediate portion of the spring, the spring is curled so that the direction (indicated by the arrow with numeral 27) of the arcuate portion around the longitudinal axis is opposite the direction (indicated by the arrow with numeral 28) of the windings of intermediate portion. The reversing of the winding direction forms a well defined radially extending opening (indicated by the arrow 29) into the space encircled by the arcuate portion and thus facilitates a more easy fitting of the spring into the groove of the valve member or plunger.

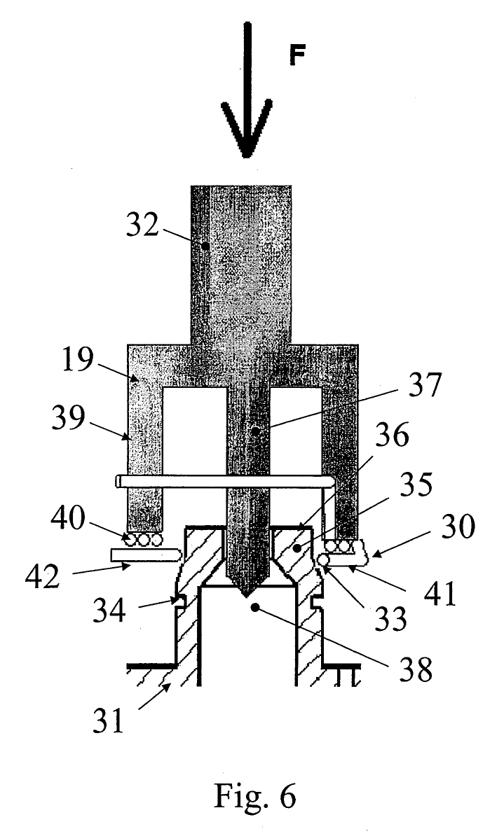

FIG. 6 shows a cross-sectional view of a spring 30, a valve member 31 and a pressing tool 32 for pressing the first end portion 33 of the spring into the groove 34 of the main valve member. The main valve member comprises a top portion 35 tapering conically inwardly from the groove 34 towards the end 36 thereby forming an end with a smaller radial size than the radial size of the groove. During the assembly process, the pressing tool comprises a centre guiding pin 37 which engages the pilot passage 38 of the main valve member, and a pressing ring 39 which contacts the intermediate windings 40 which are located in a plane. When the intermediate windings are pressed downwardly, they contact the adjacent connecting wire portion 41 and the free wire end portion 42 of the spring and thereby press the first end portion of the wire downwardly until the end winding engages the groove. The spring thereby allows the end of the valve member to be inserted into the spring in an easy manner in an axial direction.

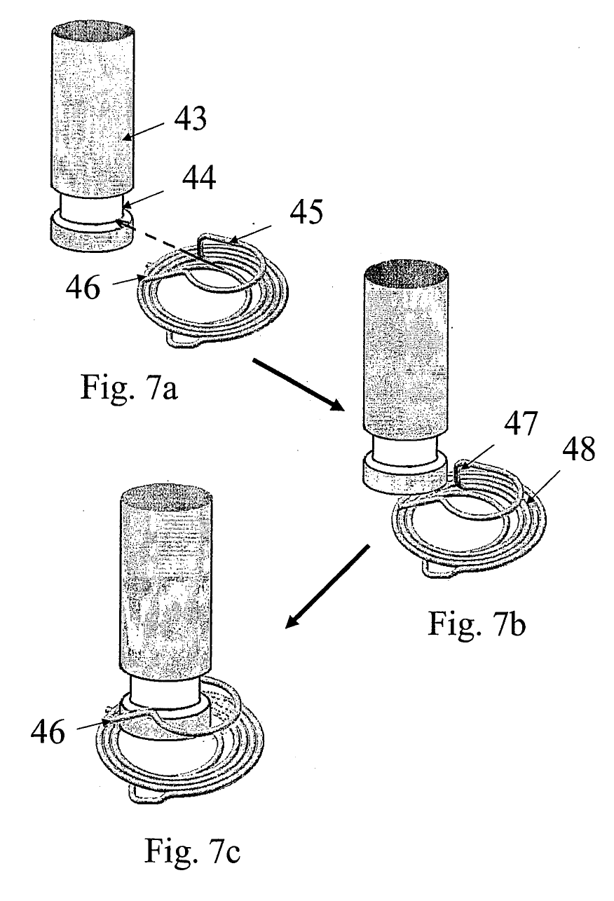

FIGS. 7a-7c show in a perspective view, a sequence of a plunger 43 with a circumferentially extending groove 44. The groove is inserted radially into the second end winding 45. For this purpose, the free wire end portion 46 which extends radially away from the longitudinal centre axis of the spring serves to guide the plunger into the end winding, and the axially extending connecting wire portion 47 provides a distance between the second end winding and the adjacent winding 48 of the intermediate portion so that the plunger can enter into the end winding without colliding with the windings of the intermediate portion.

While the present invention has been illustrated and described with respect to a particular embodiment thereof, it should be appreciated by those of ordinary skill in the art that various modifications to this invention may be made without departing from the spirit and scope of the present invention.

What is claimed is:

1-11. (canceled)

12. A spring made from a wire which is wound around a longitudinally extending axis, the spring comprising an intermediate portion with intermediate windings wound in one common plane in a general winding direction around the axis, the common plane being located between axially opposite end portions terminating the spring in first and second end windings, the first end winding comprises an arcuate portion wherein the wire extends around the axis, a connecting wire portion extending towards the intermediate portion, and a free wire end portion, the windings of the intermediate portion having a larger inner diameter than the end windings.

13. The spring according to claim 12, wherein at least a part of the connecting wire portion extends outwardly away from the axis.

14. The spring according to claim 12, wherein the arcuate portion is a circular portion wherein the wire extends circularly around a centre point, and wherein at least one of the connecting wire portion and the free wire end portion extends radially outwardly away from the centre point.

15. The spring according to claim 12, wherein at least one of the first and second end winding is wound in a direction being opposite to the general winding direction around the axis.

16. The spring according to claim 12, wherein the intermediate portion comprises windings with a larger radial size than one of the first and second end windings.

17. The spring according to claim 12, wherein each of the intermediate windings has different radial sizes, and wherein the intermediate windings are located in one common plane.

18. The spring according to claim 17, wherein at least one of the free wire end portion and the connecting wire portion of the first end portion is parallel to the plane.

19. The spring according to claim 12, wherein the second end portion comprises an arcuate portion wherein the wire extends around the axis, a connecting wire portion extending towards the intermediate portion, and a free wire end portion extending outwardly away from the axis.

20. The spring according to claim 19, wherein the connecting wire portion of the second end portion extends in the longitudinal direction to provide a distance between the second end winding and an adjacent winding of the intermediate portion which distance is larger than distances between adjacent windings of the intermediate portion.

21. A valve with a spring according to claim 12, the valve forming a passage between an inlet and an outlet and comprising a valve member movable between a closed and an open position for closing and opening the fluid passage, and a plunger operative to move the valve member between the closed and the open position, the plunger being fixed to one of the end windings of the spring and the valve member being fixed to the other end winding whereby the plunger and valve member are interconnected by the spring, the spring being formed to allow movement of at least one of the valve member and plunger through the intermediate portion.

22. The valve according to claim 21, wherein the valve member comprises a pilot passage between a main valve passage and a pilot chamber.

23. The valve according to claim 21, wherein the windings of the intermediate portion are distorted away from the common plane.
